(19) United States
(12) Patent Application Publication
(10) Pub. No.: US 2016/0273464 A1
(43) Pub. Date: Sep. 22, 2016

(54) APPARATUS AND METHOD FOR MANAGING AN ENGINE IN THE PRESENCE OF COMBUSTIVE GASES

(71) Applicant: Cinaruco International, S.A., Panama City, PA (US)

(72) Inventor: Louis J. Wardlaw, Jakarta (ID)

(21) Appl. No.: 14/662,848

(22) Filed: Mar. 19, 2015

(51) Int. Cl. F02D 41/00; F02M 65/00; F02D 41/22

(52) U.S. Cl. CPC F02D 41/0025; F02D 41/0002; F02D 41/22; F02M 65/006

(57) ABSTRACT

An assembly for managing an engine in the presence of hydrocarbons may include a first hose, a second hose, a tank, a sensor, a shutoff valve, and a flapper valve. The first hose may provide pressurized air to the valve. The valve may be closed when receiving the pressurized air and opened when receiving pressurized air below a threshold. The tank may comprise carbon dioxide and may be connected to the valve. The second hose may provide the carbon dioxide from the valve to the manifold of the engine when the valve is opened. The sensor may be configured to detect the presence of hydrocarbons in the pressurized air. The shut off valve may be configured to reduce a pressure of the pressurized fluid at the valve when the sensor detects the presence of hydrocarbons. The flapper valve may provide air to a manifold of the engine.

### BACKGROUND INFORMATION

1. Field

The present invention generally relates to a method and apparatus for managing an engine in an environment that may be subject to combustive gases. More particularly the invention relates to a system and methodology for providing a controlled shut down of an engine when combustive gases are detected in an environment proximate the engine.

2. Background

In the field of engine management, safety is an ongoing concern. There are various settings and environments that can give rise to dangerous operating conditions. The danger may arise as a potential damage to the engine and/or a potential damage to the surrounding environment. Such settings may be industrial in nature. One example of such an environment that is subject to risk may found on oil and gas drilling facilities, such as offshore platforms, production facilities and the like. In these settings industrial activities of various sorts regularly occur in close proximity to areas in which the activities would be considered dangerous, or in which the environment in general is not suited for performing certain activities.

Various engines may subject to operating risks. These include combustion engines such as diesel engines and gasoline engines. Gas turbine engines also have this risk. Equipment linked to or associated with the engines such as compressors and pumps may share the risk. Other kinds of equipment as well may be subject to the operating risk.

One such kind of risk is the unintended introduction of combustible gases, such as hydrocarbons, into the air intake of a fueled engine. Fuel is typically introduced through a controlled system such as a fuel injection system or carburation system. Combustible gas that may be present in the atmosphere or environment proximate the engine may be drawn into the air intake of the engine along with the air. This can lead to a fuel overload to the engine and uncontrolled combustion. It would be desirable to manage this kind of risk along with other risks.

During a decrease in rpm of an engine, a throttle, fuel injection controller, or some other device typically decreases the amount of fuel introduced into the combustion chambers. However, hydrocarbons present in the air intake may serve to offset this decrease in fuel. Likewise during an increase in rpm or acceleration, the throttle, fuel injection controller, or other device, increases the amount of fuel introduced. Combustible gas present in the air intake may give rise to an unwanted or unanticipated surge in the engine.

Diesel engines may be susceptible to a loss of control due to combustible gas in the air intake. This condition is known as diesel engine runaway. During diesel engine runaway, the engine draws extra fuel from an unintended source and overspeeds at higher and higher RPM. If not controlled, the overspeed may continue until the engine is destroyed by mechanical failure or bearing seizure through lack of lubrication. A number of industrial accidents have arisen because of this problem.

A number of settings may give rise to the inadvertent presence of combustible gases. For example, a number of different operations may occur in a relatively confined setting in the case of offshore drilling platforms and other oil and gas operations, including production wells, transportation, storage, and processing a number of hydrocarbons. In off shore wells, it is commonly necessary to perform a variety of operations, including so-called “hot work,” such as welding, cutting, grinding, and the like, in a relatively confined environment. Further, combustible gas may inadvertently arise in such an environment, from the production of hydrocarbons or from other sources, such as fuel used in welding operations. These are examples of environments in which it may be desirable to consider engine management in the presence of unwanted and unintended hydrocarbons.

Thus, it would be advantageous to have a method and apparatus that takes into account at least some of the issues discussed above, as well as possibly other issues.

### SUMMARY OF THE INVENTION

In one illustrative embodiment, an apparatus for managing fluid input to an engine is provided. The apparatus may comprise a first source of fluid having a pressure above a threshold, a second source of a noncombustive fluid, a valve fluidly connected to the first source and the second source, and a sensor associated with the first source. The sensor may detect combustive gas present in the fluid. The first source may be configured to reduce the pressure of the fluid below the threshold when the sensor detects combustive gas. The valve may be configured to admit the noncombustive fluid to an engine input when the pressure of the fluid falls below the threshold. The noncombustive fluid may serve to control engine operation including achieving a controlled shutdown of the engine.

In another illustrative embodiment, an assembly for managing an engine in the presence of hydrocarbons is provided. The assembly may include a first hose, a second hose, a tank, a sensor, a shutoff valve, and a flapper valve. The first hose may provide pressurized air to the valve. The valve may be closed when receiving the pressurized air and opened when receiving pressurized air below a threshold. The tank may comprise carbon dioxide and may be connected to the valve. The second hose may provide the carbon dioxide from the valve to the manifold of the engine when the valve is opened. The sensor may be configured to detect the presence of hydrocarbons in the pressurized air. The shut off valve may be associated with the sensor and may be configured to reduce a pressure of the pressurized fluid at the valve when the sensor detects the presence of hydrocarbons. The flapper valve may provide air to a manifold of the engine.

In still a further embodiment, a method for managing the operation of a combustion engine in the presence of hydrocarbons may be provided. The method may include steps such as providing air to a valve above a threshold pressure so as to maintain the valve in the closed position; reducing the pressure of the air below the threshold pressure when hydrocarbons are detected by a sensor; and opening the valve to a carbon dioxide source so as to admit the carbon dioxide to an engine manifold. The method may further include detecting by a sensor the presence of hydrocarbons thereby opening a bleed valve to reduce the pressure of the air below the threshold pressure; and admitting a volume of carbon dioxide into the engine manifold so as to close an air intake valve to the manifold. The carbon dioxide admitted to the engine manifold may diminish combustion in the engine.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives, and features thereof, will best be understood by reference to the following detailed description of an illustrative embodiment of the present disclosure when read in conjunction with the accompanying drawings, wherein:

FIG. 1 is an illustration of a block diagram of an engine environment in accordance with an illustrative embodiment;

FIG. 2 is an illustration of an engine control system in accordance with an illustrative embodiment;

FIG. 3 is an illustration of a further engine control system in accordance with an illustrative embodiment, and

FIG. 4 is an illustration of a flowchart of a process for managing an engine in the presence of hydrocarbons in accordance with an illustrative embodiment.

### DETAILED DESCRIPTION

The different illustrative embodiments recognize and take into account one or more different considerations in the current technology. For example, without limitation, the different illustrative embodiments recognize and take into account that existing structures and methods do not provide a safe control system for engines operating in an environment that may be subject to combustible gases.

The different illustrative embodiments also recognize and take into account that currently known technology does not provide an automated method or system for providing a controlled operation or shut down of an engine when combustible gases are detected proximate the system. Ad hoc manual systems, such as manually covering an air intake with whatever material is at hand have been attempted in the past to smother a runaway diesel engine. However these manual attempts at engine control are highly dangerous and are also ineffective.

The different illustrative embodiments recognize that attempted manual control of an uncontrolled or runaway engine is inherently dangerous. Covering an air intake such as an air manifold involves an engine operator placing his person in close proximity to the runaway engine so as to position some kind of blocking device over the air intake. For certain kinds of engines, such as large diesel engines, it may be physically impossible for an individual to approach the air intake. In the uncontrolled state the engine is highly dangerous and may throw off ancillary systems such as belts; and the engine block is always liable to explode. Personal injury is a risk when an operator approaches an uncontrolled engine, and it is thus not safe for an individual to approach such an engine. Further, when in a runaway state, a large volume engine may generate a significant suction at the air intake. This suction is extremely dangerous and may act to physically suck the individual into the air intake. It would therefore be desired to develop automated systems and methods of engine control that do not include an individual approaching an engine during uncontrolled operation.

Manual shutdown techniques are also highly variable and ineffective. They may involve an operator quickly grabbing whatever is at hand to cover an air intake. Soft items such as rags or cardboard are not effective at providing a controlled stoppage of the engine. Large bore engines may simply suck in such items and continue in a runaway state. Due to their size, it may simply not be possible to smother large engines, such a diesel locomotive or as may be present on a drilling platform.

Further, the different illustrative embodiments also recognize and take into account that currently known manual methods for controlling a runaway engine only occur after the uncontrolled state of operation has already been reached. The current methods do not provide sensors so as to detect those conditions that may give rise to the uncontrolled state of operation.

The different illustrative embodiments also recognize and take into account that an effective engine control is needed that would not involve a human operator approaching an engine at all. It would be desired to provide an automated method for managing an engine in the presence of combustive gases.

Thus, the different illustrative embodiments provide a method and apparatus for managing an engine subject to the presence of combustible gases. For example, one illustrative embodiment provides an apparatus for managing fluid input to an engine. The apparatus may comprise a first source of fluid having a pressure above a threshold, a second source of a noncombustive fluid, a valve fluidly connected to the first source and the second source, and a sensor associated with the first source. The sensor may detect combustive gas present in the fluid. The first source may be configured to reduce the pressure of the fluid below the threshold when the sensor detects combustive gas. The valve may be configured to admit the noncombustive fluid to an engine input when the pressure of the fluid falls below the threshold. The noncombustive fluid may serve to control engine operation including achieving a controlled shutdown of the engine.

A further illustrative embodiment, an assembly for managing an engine in the presence of hydrocarbons is provided. The assembly may include a first hose, a second hose, a tank, a sensor, a shutoff valve, and a flapper valve. The first hose may provide pressurized air to the valve. The valve may be closed when receiving the pressurized air and opened when receiving pressurized air below a threshold. The tank may comprise carbon dioxide and may be connected to the valve. The second hose may provide the carbon dioxide from the valve to the manifold of the engine when the valve is opened. The sensor may be configured to detect the presence of hydrocarbons in the pressurized air. The shut off valve may be associated with the sensor and may be configured to reduce a pressure of the pressurized fluid at the valve when the sensor detects the presence of hydrocarbons. The flapper valve may provide air to a manifold of the engine.

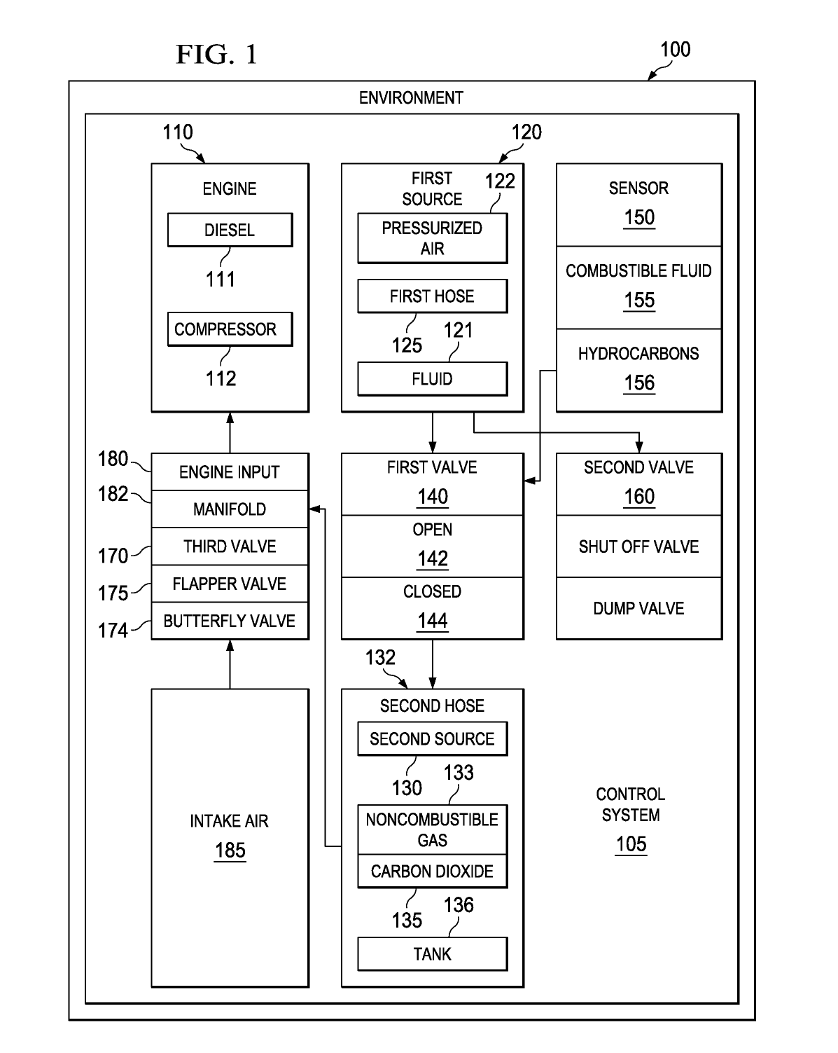

With reference now to the figures and, in particular, with reference to FIG. 1, an illustration of a block diagram of an engine environment is depicted in accordance with an illustrative embodiment. Environment 100 may include engine 110 and control system 105. Control system 105 may include first source 120, second source 130, and first valve 140. Engine 110 may comprise an internal combustion engine such as diesel engine 111 or compressor 112. In addition engine 110 may comprise a gas engine or gas turbine engine.

In these examples, the different components in control system 105 may be associated with each other. A first component may be considered to be associated with a second component by being secured to the second component, bonded to the second component, fastened to the second component, and/or connected to the second component in some other suitable manner. The first component also may be connected to the second component through using a third component. The first component may also be considered to be associated with the second component by being formed as part of and/or as an extension of the second component.

Unless otherwise noted and where appropriate, similarly named features and elements of illustrative embodiments of one figure of the disclosure correspond to and embody similarly named features and elements of embodiments of the other figures of the disclosure.

First source 120 may comprise a source of fluid 121. Fluid 121 may comprise a compressed gas or fluid such as pressurized air 122. First source 120 may also comprise first hose 125 which includes fluid 121. Pressurized air 122 present in first source 120 may be provided by a further mechanism such as a compressor, not shown.

First source 120 may provide fluid 121, such as pressurized air 122, through first hose 125 to first valve 140. First valve may have an open position 142 and a closed position 144. First valve 140 may be configured such that when fluid 121 or pressurized air 122 is provided through first hose 125 to first valve 140, first valve remains in the closed position 144. However, if a pressure in fluid 121 or pressurized air 122 to first valve 140 is reduced, then first valve 140 transitions to an open position.

Second source 130 may provide a source of noncombustible gas 133. Noncombustible gas 133 may comprise carbon dioxide (CO₂) 135. Second source 130 may comprise tank 136 that includes carbon dioxide 135. In one illustrative embodiment, second source 130 comprises a cylinder of compressed carbon dioxide 135. First valve 140 may be associated with second source 130.

Second source 130 may also comprise second hose 132. Second hose 132 may be connected to first valve 140. Second hose 132 may be configured so as to deliver noncombustible gas 133 from first valve 140 to engine input 180. When first valve 140 is in the closed position, noncombustible gas 133 cannot pass through first valve 140 and noncombustible gas 133 may be confined in tank 136. However, when first valve 140 is in the open position, noncombustible gas 133 may pass through first valve 140, through second hose 132 and into engine input 180.

Control system 105 may also include sensor 150. Sensor 150 may be positioned in environment 100, and may be positioned proximate engine 110. Sensor 150 may be configured to detect combustible fluid 155. Sensor 150 may also be configured so as to detect concentrations of combustible fluid 155 in environment 100. Sensor 150 may be configured so as to detect combustible fluid that is present at or above a defined concentration, a defined level. The concentration of combustible fluid below the defined level may not constitute a risk for uncontrolled operation of engine 110. The concentration of combustible fluid at or above the defined level may constitute a risk for uncontrolled operation of engine 110.

Combustible fluid 155 may include any kind of fluid or gas that can give rise to an uncontrolled operation of engine 110. Combustible fluid 155 may include hydrocarbons 156. Combustible fluid 155 may arise from fuel leaks or from the production of petroleum. Combustible fluid 155 may also arise from welding fuels comprising, for example, acetylene. Hydrogen may also be included within combustible fluid 155.

Second valve 160 may be associated with first source 120. Second valve 160 may have a first position and a second position. Second valve 160 may be configured such that in the first position a compressed fluid, such as compressed air, passes through first source 120 to first valve 140. In the second position, second valve 160 may be configured so as to release compressed fluid from first source 120. Second valve 160 may comprise a shut off valve or dump valve.

Sensor 150 may be associated with second valve 160. In a set up corresponding to normal conditions, when sensor 150 detects combustible gases are below a determined concentration, second valve 160 may be in the first position. However, when sensor 150 detects that combustible gases are present at or above a determined concentration, second valve 160 may be in the second position.

Engine 110 may include engine input 180. In one illustrative embodiment engine input 180 comprises manifold 182. As part of its normal operation, engine 110 may receive intake air 185 through engine input 180. Intake air 185 may comprise the ambient air in environment 100 that is used to operate engine 110. When combustible fluid 155 is present in intake air 185, combustible fluid 155 may lead to an out of control operation of engine 110.

Third valve 170 may be associated with engine input 180. Third valve 170 may comprise butterfly valve 174 or flapper valve 175. Third valve 170 may control the admission of intake air 185 into engine input 180.

In operation, control system 105 may be configured so as to provide for the controlled stoppage or deceleration of engine 110 when combustible fluid 155 is detected in environment 100 or proximate engine 110. When combustible fluid 155 is below a determined concentration, engine 110 operates in a normal manner. First source 120 maintains delivery of fluid 121 at its pressurized level. Fluid 121 in first source 120 is in fluid communication with first valve 140. The presence of fluid 121 at or above a threshold pressure at first valve 140 maintains first valve 140 in a closed position. When first valve 140 is in the closed position, noncombustible gas 133 from second source 130 remains confined. For example, a closed first valve 140 maintains a compressed carbon dioxide 135 in its tank 136.

If conditions in environment 100 change from the normal operation, a combustible fluid 155 at sensor 150 puts into play a number of steps. As the concentration of combustible fluid 155 rises above a determined concentration, sensor 150 detects this rise in concentration. Second valve 160 is enabled so as to switch from first position to second position. In second position, second valve 160 allows fluid 121 to pass out of first source 120. Second valve, in an illustrative embodiment, comprises a dump valve associated with first hose 125. Opening the dump valve allows pressurized air 122 to dump out of first hose 125.

The loss of pressure in fluid 121 below a threshold pressure acts upon first valve 140. First valve 140 transitions from closed position 144 to open position 142. The opening of first valve 140 allows noncombustible gas 133 to exit tank 136, pass through second hose 132, and pass into engine input 180. Further, noncombustible gas 133 is admitted into engine input 180 at such a volume that noncombustible gas 133 smothers combustion taking place in engine 110. The result is a controlled shut down of engine 110.

As a further alternative illustrative embodiment, the volume of noncombustible gas 133, acting within manifold 182, may be sufficient to close third valve 170. The closing of third valve 170, such as the closing of flapper valve 175, also serves to cut off the admission of intake air 185 and the unwanted combustible fluid 155 into engine 110. This additionally and/or alternatively serves to shut down engine 110.

In describing the operation of control system 105, second valve 160 was described as being enabled when sensor 150 detects the presence of combustible fluid 155 at or above a concentration level that gives rise to potential runaway operation. A number of method and means may connect sensor 150 with second valve 160 that is beyond the scope of the current disclosure. For example, sensor 150 may be associated with a controller that also provides activation/control to second valve 160 when the controller receives data from sensor 150. Alternatively, sensor 150 may be directly linked to second valve 160, which is controlled by a signal from sensor 150. Other means of activating second valve 160 based on a signal from sensor 150 will be understood by those skilled in the art.

The above-described system and method of operation provides an automated means for controlling and shutting down an engine when in the presence of combustible fluid 155. No operator input is necessary, and it is not necessary for any human operator to approach the engine in order to achieve shut down.

The illustrative embodiment outlined above also describes one first source, one second source, and one sensor; however in other embodiments there may be more than one of each source.

As used herein, the phrase “at least one of”, when used with a list of items, means that different combinations of one or more of the listed items may be used and only one of each item in the list may be needed. For example, “at least one of item A, item B, and item C” may include, for example, without limitation, item A or item A and item B. This example also may include item A, item B, and item C, or item B and item C. In other examples, “at least one of” may be, for example, without limitation, two of item A, one of item B, and 10 of item C; four of item B and seven of item C; and other suitable combinations.

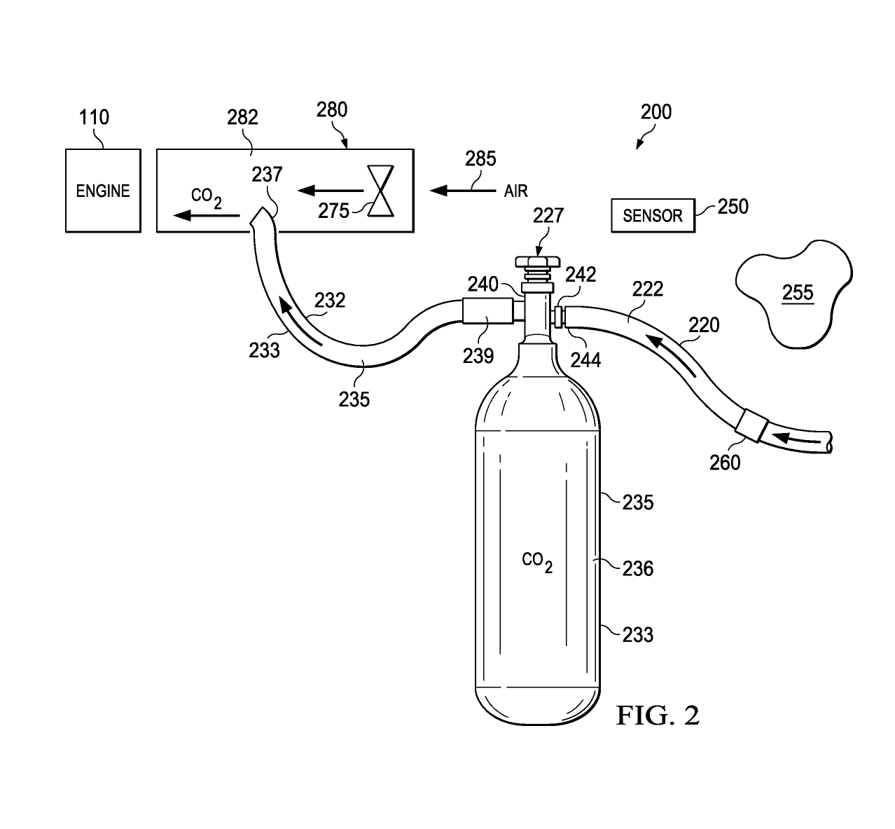

With reference now to FIG. 2, an illustration of an engine control system is depicted in accordance with an illustrative embodiment. Engine control environment 200 may include engine 110 as depicted in FIG. 1.

Engine input 280 may be associated with engine 110. Engine input 280 may comprise manifold 282. Manifold 282 provides an intake air 285 to engine 110. In the illustrative example, manifold 282 further includes flapper valve 275. Flapper valve 275 provides a controlled pathway for air to pass into manifold 282 and then into engine 110. While depicted as flapper valve 275 in FIG. 2, other kinds of valves may also serve this function, including for example, butterfly valves and throttle valves.

First hose 220 includes first end 227 associated with first valve 240. First hose 220 may provide fluid 222 to first valve 240. In one illustrative embodiment, fluid 222 comprises a pressurized gas such as pressurized air. In one illustrative embodiment, fluid 222 such as pressurized air may be provided to first hose 220 from a further element or piece of machinery such as a compressor, not shown.

Second hose 232 includes first end 237. First end 237 may be associated with manifold 282 so as to provide fluid communication between second hose 232 and manifold 282. Second hose 232 may be configured to transport noncombustible gas 233 including, for example, carbon dioxide 235. Second end 239 of second hose 232 may be associated with first valve 240.

First valve 240 may be associated with tank 236. Tank 236 provides a source of noncombustible gas 233, such as carbon dioxide 235. First valve 240 may transition between open position 242 and closed position 244. In closed position 244, first valve 240 prevents the passage of noncombustible gas 233 from tank 236 through second hose 232 to manifold 282. In open position 242, first valve 240 allows the flow of noncombustible gas 233 from tank 236 through second hose 232 to manifold 282. In open position 242, first valve 240 and tank 236 may be configured so as to provide a volume and pressure of noncombustible gas 233 so as to control or decrease the operation of engine 110. In open position 242, the flow of noncombustible gas 233 through manifold 282 and into engine 110 may provide for a controlled shut down of engine 110.

Fluid 222, including pressurized air, in first hose 220 may be maintained above a threshold pressure. Above the threshold pressure, fluid 222 maintains first valve 240 in closed position 244. If fluid 222 falls below the threshold pressure, first valve 240 transitions to the open position 242.

Sensor 250 may be positioned in an environment proximate engine 110. Sensor 250 may be configured to detect the presence of combustible fluid 255 in the environment. Sensor 250 may be configured to detect and determine concentrations of combustible fluid 255. In one illustrative embodiment, combustible fluid 255 comprises hydrocarbons that may give rise to an uncontrolled operation of engine 110 such as a runaway condition.

Second valve 260 may be associated with first hose 220. Sensor 250 may be in communication with second valve 260 such that second valve 260 may open or close based on the concentration level of combustible fluid 255 determined by sensor 250. Second valve 260, when closed, maintains fluid 222, such as pressurized air, within first hose 220 above a threshold level. However, second valve 260, when opened, allows fluid 222 to exit first hose 220 such that the pressure of pressurized air or fluid 222 falls below the threshold level. When the pressure of pressurized air or fluid 222 within first hose falls below the threshold level, first valve 240 transitions to the open position 242.

Sensor 250 may be directly linked to second valve 260. Alternatively, sensor 250 may be indirectly linked to second valve 260 through a data processor device such as a controller, microcontroller, or computer.

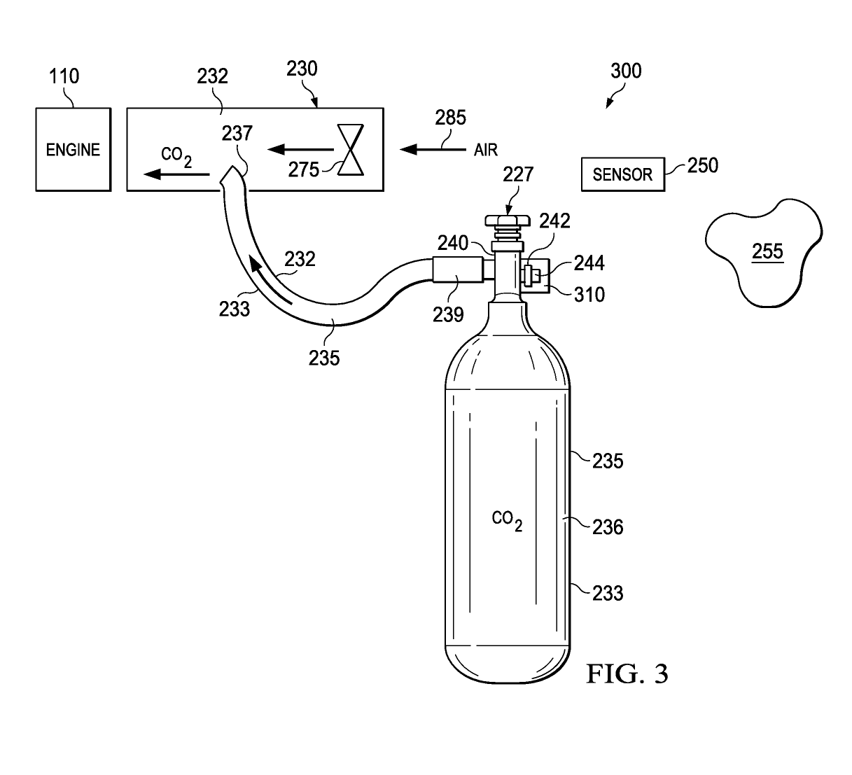

With reference now to FIG. 3, an illustration of an engine control system is depicted in accordance with an illustrative embodiment. Engine control system 300 may include engine 110 as depicted in FIG. 1.

In a further embodiment, sensor 250 is directly linked to actuator 310 which controls first valve 240. Actuator 310 may comprise an electromechanical device that controls the opening and closing of first valve 240. For example a signal from sensor 250 indicating the presence of hydrocarbons may cause actuator 310 to open first valve 240. In the absence of any signal indicating the presence of hydrocarbons, sensor 250 sends a signal or no signal that causes actuator 310 to maintain first valve 240 in a closed position.

It may be noted that the other features of the illustrative embodiment in FIG. 3 are the same as those shown in FIG. 2 except that the illustrative embodiment in FIG. 3 eliminates the feature of the first hose 220 and fluid (or pressurized air) 222. In FIG. 3, first valve 240 is operated by actuator 310 rather than fluid or pressurized air 222.

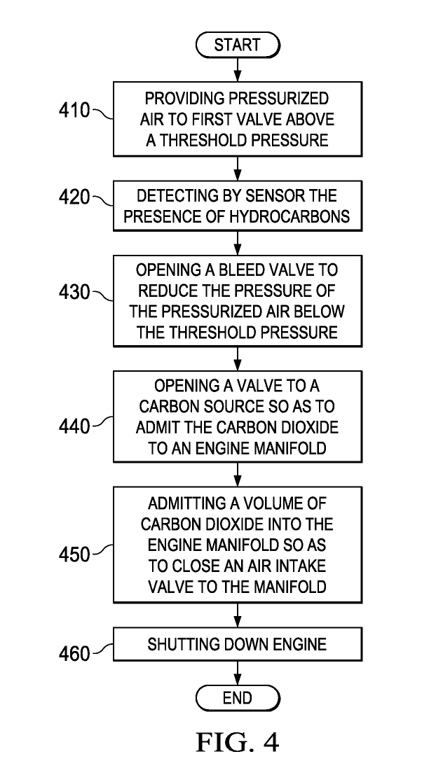

With reference now to FIG. 4, an illustration of a flowchart of a process for managing the operation of an engine in the presence of hydrocarbons is depicted in accordance with an illustrative embodiment. The process illustrated in FIG. 2 may be implemented using control system 105 with engine 110 as depicted in environment 100 in FIG. 1.

The process may begin by providing pressurized air 122 to first valve 140 above a threshold pressure (operation 410). Pressurized air 122 maintains first valve 140 in a closed position.

A further step may include detecting by sensor 150 the presence of hydrocarbons 156 (operation 420). The step of opening a bleed valve to reduce the pressure of the pressurized air 122 below the threshold pressure may follow (operation 430).

A further step may include opening a valve to a carbon dioxide source so as to admit the carbon dioxide to an engine manifold (operation 440).

Still a further step may include admitting a volume of carbon dioxide into the engine manifold so as to close an air intake valve to the manifold (operation 450). The carbon dioxide admitted to the engine manifold diminishes combustion in the engine.

As still a further step, engine 110 may be shut down (operation 460). Engine 110 may be shut down as a consequence of carbon dioxide or some other noncombustible gas admitted into engine in step 450. Engine 110 may be shut down in a controlled manner by managing the volume and mass of gas admitted to engine 110.

The description of the different advantageous embodiments has been presented for purposes of illustration and description and is not intended to be exhaustive or limited to the embodiments in the form disclosed. Many modifications and variations may be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. An apparatus for managing fluid input to an engine comprising:
a first source of fluid having a pressure above a threshold;
a second source of a noncombustive fluid;
a valve fluidly connected to the first source and the second source; and
a sensor associated with the first source and configured to detect combustive gas in the fluid, the first source configured to reduce the pressure of the fluid below the threshold when the sensor detects combustive gas;
wherein the valve is configured to admit the noncombustive fluid to an engine input when the pressure of the fluid falls below the threshold.

2. The apparatus of claim 1, wherein the valve comprises a first valve and further comprising a second valve associated with the sensor and the first source, the second valve configured to reduce the pressure of the fluid below the threshold when the sensor detects the presence of combustive gas.

3. The apparatus of claim 2, wherein the second valve comprises a shut off valve.

4. The apparatus of claim 1, further comprising an intake valve providing a one way air intake to the engine input.

5. The apparatus of claim 4, wherein the intake valve comprises a flapper valve controlling admission of air to the engine input.

6. The apparatus of claim 4, wherein the noncombustive fluid admitted to the engine input closes the intake valve.

7. The apparatus of claim 1, wherein the fluid comprises air.

8. The apparatus of claim 1, wherein the noncombustive fluid comprises carbon dioxide gas.

9. The apparatus of claim 1, wherein the engine input comprises a manifold to the engine.

10. The apparatus of claim 1, wherein the sensor is disposed proximate the engine so as to detect combustive gases that may adversely affect engine operation.

11. The apparatus of claim 1, wherein the engine comprises a compressor or diesel engine.

12. An assembly for managing an engine in the presence of hydrocarbons comprising:
a valve;
a first hose providing pressurized air to the valve, the valve closed when receiving the pressurized air and opened when receiving pressurized air below a threshold;
a tank of carbon dioxide connected to the valve;
a manifold of the engine;
a second hose providing the carbon dioxide from the valve to the manifold of the engine when the valve is opened;
a sensor configured to detect hydrocarbons in an environment around the engine;
a shut off valve associated with the sensor and configured to reduce a pressure of the pressurized air at the valve when the sensor detects hydrocarbons; and
a flapper valve providing air to the manifold of the engine.

13. The assembly of claim 12, wherein the carbon dioxide admitted to the manifold closes the flapper valve.

14. The assembly of claim 12, wherein the shut off valve dumps pressurized air from the first hose when the sensor detects hydrocarbons.

15. The assembly of claim 12, wherein the sensor is disposed proximate the engine so as to detect combustive gases that may adversely affect engine operation.

16. The assembly of claim 12, wherein the valve when opened admits a volume of carbon dioxide to the manifold of the engine so as to stop the engine.

17. The assembly of claim 12, wherein the valve when opened admits a volume of carbon dioxide to the manifold of the engine so as to close the flapper valve.

18. The assembly of claim 12, wherein the engine comprises a compressor or diesel engine.

19. A method for managing the operation of a combustion engine in the presence of hydrocarbons, the method comprising the steps of:
providing air to a valve above a threshold pressure so as to maintain the valve in a closed position;
reducing the pressure of the air below the threshold pressure when hydrocarbons are detected by a sensor; and
opening the valve to a carbon dioxide source so as to admit the carbon dioxide to an engine manifold.

20. The method of claim 19, further comprising detecting by a sensor hydrocarbons thereby opening a bleed valve to reduce the pressure of the air below the threshold pressure.

21. The method of claim 19, further comprising admitting a volume of carbon dioxide into the engine manifold so as to close an air intake valve to the manifold.

22. The method of claim 19, wherein the carbon dioxide admitted to the engine manifold diminishes combustion in the engine.
